(19) United States
(12) Patent Application Publication
(10) Pub. No.: US 2018/0189043 A1
(43) Pub. Date: Jul. 5, 2018

(54) SYSTEM AND METHOD FOR CONTROLLING A NETWORK CONNECTED DEVICE

(71) Applicant: Digital Turbine, Inc., Austin, TX (US)

(72) Inventor: Tony HABAYEB, Haifa (IL)

(21) Appl. No.: 15/396,846

(22) Filed: Jan. 3, 2017

(51) Int. Cl. G06F 9/445; H04L 29/08

(52) U.S. Cl. CPC G06F 8/61; H04L 67/141; H04L 67/34

(57) ABSTRACT

A network connected device, adapted to instruct, comprising: a local digital memory hardware, a code storage storing a code and a hardware processor coupled to the local digital memory hardware and the code storage for executing the code. The code is for: receiving instructions to install a software module in a target device, acquiring an installation file of the software module from a server via a network, storing the installation file to the local digital memory hardware, instructing the target device to participate in establishing a network connection between the network connected device and the target device for installing said installation file on a local memory of said the device, and instructing the target device to use the network connection for downloading the installation file from the local digital memory hardware for installation.

### FIELD AND BACKGROUND OF THE INVENTION

The present invention, in some embodiments thereof, relates to network connected devices for controlling one network connected device from another network connected device and, more specifically, but not exclusively, to network connected devices for installing a software module on a network connected device from another network connected.

One problem dealt with by the present invention is the need to instruct the installation of a software module on a target device from a source device. The installation file for the software module may be stored on a server but the target device might not be connected to the server. There is a need to deliver the installation file to the target device and instruct the target device to install the installation file.

### SUMMARY OF THE INVENTION

It is an object of the invention to provide a network connected device capable of instructing another network connected device to acquire and install a software module installation file, and to provide a network connected device capable of receiving and executing instructions to acquire and install a software module installation file.

The foregoing and other objects are achieved by the features of the independent claims. Further implementation forms are apparent from the dependent claims, the description and the figures.

According to a first aspect of the invention, a network connected device, adapted to instruct, comprises: a local digital memory hardware, a code storage storing a code and a hardware processor coupled to the local digital memory hardware and the code storage for executing the code. The code is for: receiving instructions to install a software module in a target device, acquiring an installation file of the software module from a server via a network, storing the installation file to the local digital memory hardware, instructing the target device to participate in establishing a network connection between the network connected device and the target device for installing the installation file on a local memory of the target device, and instructing the target device to use the network connection for downloading the installation file from the local digital memory hardware for installation. Having network connections to a server and a target device enables instructing the installation of a software installation file stored on the server on to a target device that is unable to connect to the server.

According to a second aspect of the invention, a network connected device, adapted to install, comprises: a local digital memory hardware, a code storage storing a code and a hardware processor coupled to the local digital memory hardware and the code storage for executing the code. The code is for: receiving instructions from a source device to participate in establishing a network connection between the network connected device and the source device for installing an installation file on the local digital memory hardware, participating in establishing a network connection between the network connected device and the source device, using the network connection for downloading the installation file from the source device to the local digital memory hardware for installation, and installing the installation file to the local digital memory hardware. Having a network connection to a source device and having code for installing an installation file enables installation on the network connected device of a software module from an installation file stored on a server the network connected device cannot connect to.

According to a third aspect of the invention, a method comprises: receiving instructions on a source device to install a software module in a target device, acquiring an installation file of the software module on a source device from a server via a network, storing the installation file to a digital memory hardware local to the source device, the source device instructing the target device to participate in establishing a network connection between the source device and the target device for installing the installation file on a digital memory hardware local to the target device, the target device participating in establishing a network connection between the target device and the source device, the source device instructing the target device to use the network connection for downloading the installation file from the digital memory hardware local to the source device for installation, the target device using the network connection for downloading the installation file from the source device to the digital memory hardware local to the target device for installation, and the target device installing the installation file to the local digital memory hardware.

According to a fourth aspect of the invention, a network connected device, adapted to instruct remote acquisition, comprises: a local digital memory hardware, a code storage storing a code and a hardware processor coupled to the local digital memory hardware and the code storage for executing the code. The code is for: receiving instructions to install a software module in a target device, instructing the target device to participate in establishing a network connection between the network connected device and the target device for installing an installation file for the software module on a local memory of the target device, and instructing the target device to establish another network connection between a server and the target device for downloading the installation file from the server for installation. Having a network connection to a target device allows instructing installation of a software installation file on a target device having no other interface for instructing installation.

According to a fifth aspect of the invention, a network connected device, adapted to install from a remote server, comprises: a local digital memory hardware, a code storage storing a code and a hardware processor coupled to the local digital memory hardware and the code storage for executing the code.

The code is for: receiving instructions from a source device to participate in establishing a network connection between the network connected device and the source device for installing an installation file on the local digital memory hardware, participating in establishing a network connection between the network connected device and the source device, receiving instructions from the source device to establish another network connection between the network connected device and a server for downloading the installation file for installation, establishing another network connection between the network connected device and the server, using the other network connection for downloading the installation file from the server to the local digital memory hardware for installation, and installing the installation file to the local digital memory hardware. Having network connections to a source device and a server and having code for installing an installation file enables installation on the network connected device of a software module from an installation file stored on the server on network connected devices without another interface for instructing installation.

According to a sixth aspect of the invention, a method for remote installation comprises: receiving instructions on a source device to install a software module in a target device, the source device instructing the target device to participate in establishing a network connection between the source device and the target device for installing an installation file for the software module on a digital memory hardware local to the target device, the target device participating in establishing a network connection between the target device and the source device, the source device instructing the target device to establish another network connection between the target device and a server for downloading the installation file for installation, the target device establishing another network connection between the target device and the server, the target device using the other network connection for downloading the installation file from the server to a digital memory hardware local to the target device for installation, and the target device installing the installation file to the digital memory hardware local to the target device.

With reference to the first and fourth aspects, in a first possible implementation of the first and fourth aspects the receiving instructions to install a software module comprises: acquiring a list of software modules from the server, presenting the list of software modules to a user, receiving the user's selection of one software module of the list of software modules, and assigning the user's selection of one software module to be the software module. Requesting and receiving the list of software modules from the server allows updating the list of available software modules and the versions of the software modules without changing the software on any device.

With reference to the first and fourth aspects, in a second possible implementation of the first and fourth aspects the code is further for: discovering a set of target devices, presenting to a user a list of target devices comprising the set of target devices, receiving the user's selection of one target device of the list of target devices, and assigning the user's selection of one target device to be the target device. Discovering the set of target devices accessible by a network connected device allows adding and removing target devices without changing the network connected device.

With reference to the first and fourth aspects, in a third possible implementation of the first and fourth aspects the code is further for: receiving installation status information from the target device on the network connection, and presenting the installation status information to a user.

With reference to the second and fifth aspects, in a first possible implementation of the second and fifth aspects the code is further for using the network connection to send installation status information to the source device.

Sending installation status information from a network connected device adapted to install to a network connected device adapted to instruct and presenting the installation status information allows a user to be informed of the outcome of an installation instruction.

With reference to the second and fifth aspects, in a second possible implementation of the second and fifth aspects the code comprises application software adapted to perform the installation, an operating system adapted to allow application software to perform the installation or middleware adapted to allow application software to perform the installation.

With reference to the third aspect, in a first possible implementation of the third aspect the receiving instructions on a source device to install a software module comprises: acquiring a list of software modules from the server, presenting the list of software modules to a user, receiving the user's selection of one software module of the list of software modules, and assigning the user's selection of one software module to be the software module.

With reference to the third aspect, in a second possible implementation of the third aspect the method further comprises: discovering on the source device a set of target devices, presenting to a user a list of target devices comprising the set of target devices, receiving the user's selection of one target device of the list of target devices, and assigning the user's selection of one target device to be the target device.

With reference to the third aspect, in a third possible implementation of the third aspect the method further comprises: the target device using the network connection to send installation status information, the source device receiving the installation status information; and the source device presenting the installation status information to a user.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system comprising a device adapted to instruct and a device adapted to install according to some embodiments of the present invention;

FIG. 2 is a sequence diagram of an optional flow of operations according to the present invention where a target device downloads an installation file from a source device;

FIG. 3 is a sequence diagram of a second optional flow of operations according to the present invention where a source device sends an installation file to a target device; and

FIG. 4 is a sequence diagram of a third optional flow of operations according to the present invention where a target device downloads an installation file from a server.

### DESCRIPTION OF SPECIFIC EMBODIMENTS OF THE INVENTION

The present invention, in some embodiments thereof, relates to network connected devices for controlling one network connected device from another network connected device and, more specifically, but not exclusively, to network connected devices for installing a software module on a network connected device from another network connected.

As used herein, the term “target device” means a network connected device on which software is installed and the term “source device” means a network connected device instructing the installation of software on a target device.

There may be the need to install a software module on a target device. The installation file for the software module may be stored on a server and there is the need to deliver the installation file to the target device. There is also the need on the target device to be able to install files delivered to the target device.

As the number of network connected devices is continuously increasing, the target device may be network connected but might not be connected to a server where the installation file for the software module is stored. There is a need to deliver the installation file to the target device and instruct the target device to install the installation file. Also, there is a need to facilitate the installation of an installation file delivered to the target device.

The present invention, in some embodiments thereof, enables a source device, for example a mobile phone, to communicate with a server and acquire an installation file from the server. The source device may communicate with a target device, for example a computerized watch or computerized television, serve the installation file to the target device and instruct the target device to install the installation file. In these embodiments, the present invention enables the target device to install the installation file to a digital memory hardware local to the target device.

In other embodiments of the present invention, the target device may be able to connect to the server storing the installation file. In such embodiments, the source device may instruct the target device to acquire the installation file from the server.

The communication between the source device and the target device may use IP (Internet Protocol) based protocols for exchanging messages between the source device and the target device. The IP based protocols may use UDP (User Datagram Protocol) or TCP (Transmission Control Protocol). In embodiments using IP based protocols, the messages may be in a format understood by the source device and the target device as comprising instructions to acquire an installation file, instructions to install the installation file, installation file data and status information.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In a world where the number of network connected devices is continuously increasing a target device may be a computerized device running applications, for example a smart watch or smart television. In some embodiments of the present invention, there may be a need to install a software module to a target device. The software module may be a new version of an application already installed on the target device or an application not installed on the target device. The software module may also be middleware, for example a device driver.

In some embodiments, a target device may have at least one target communication interface. The at least one target communication interface may be wired, for example USB, or wireless, for example Bluetooth and WiFi. In some embodiments the at least one target communication interface may allow the target device to connect to a source device located near the target device, for example over a Local Area Network (LAN) but might not allow the target device to communicate with a remote server over a WAN. In other embodiments the target device may be able to communicate with a remote server over a WAN.

In some embodiments a source device may be a mobile device such as a mobile phone or tablet. In such embodiments, the source device may have at least one source communication interface. The at least one source communication interface may be wired, for example USB, or wireless, for example Bluetooth and WiFi. In some embodiments the at least one source communication interface may allow the source device to connect to a target device located near the source device, for example over a Local Area Network (LAN). In some the source device may be able to communicate with a remote server over a WAN. In some embodiments the source device may communicate with a remote server and with a target device using a common network interface, for example WiFi. In other embodiments the source device may use one network interface to communicate with the remote server, for example WiFi, and another network interface to communicate with the target device, for example Bluetooth or USB.

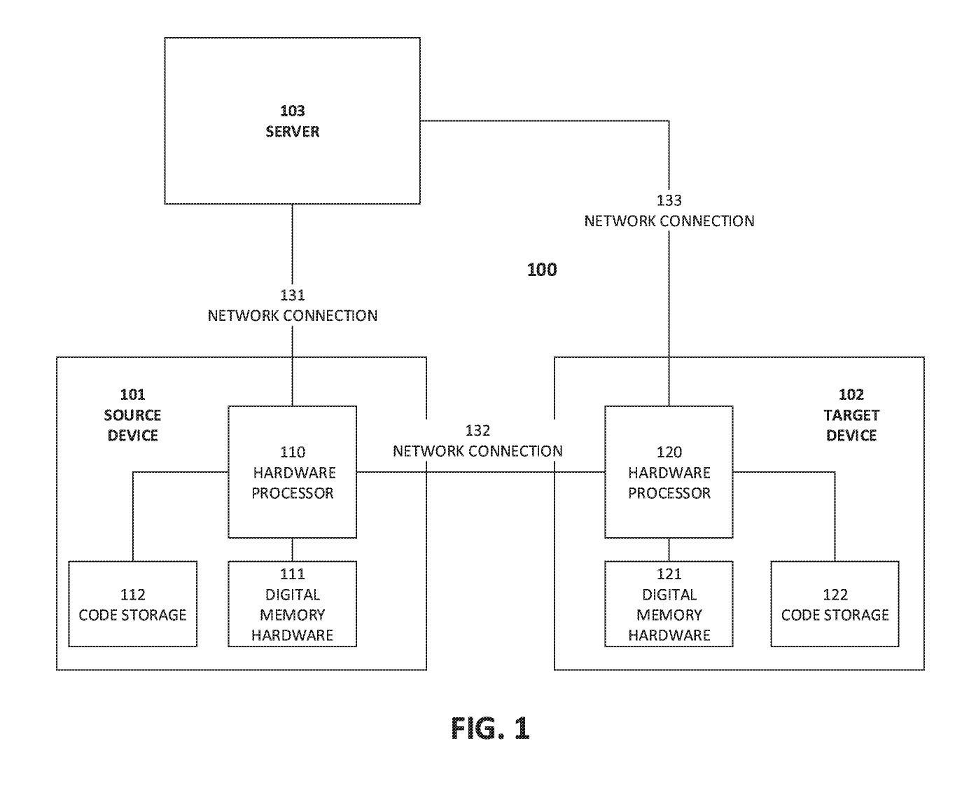

Reference is now made to FIG. 1 showing an exemplary system 100 comprising a source device 101 adapted to instruct and a target device 102 adapted to install, according to some embodiments of the present invention. In such embodiments, source device 101 may comprise a source hardware processor 110, electrically coupled to source code storage 112. Source hardware processor 110 executes source code stored in source code storage 112. Source hardware processor 110 may also be coupled to source digital memory hardware 111.

In some embodiments source device 101 may establish a network connection 132 with a target device 102. In such embodiments, target device 102 may comprise a target hardware processor 120, electrically coupled to target code storage 122. Target hardware processor 120 executes target code stored in target code storage 122. Target hardware processor 120 may also be coupled to target digital memory hardware 121.

In some embodiments network connection 132 may be via a wired network such as USB. In other embodiments, network connection 132 may be via a wireless network, for example WiFi or Bluetooth. Source device 101 and target device 102 may communicate over network connection 132 using IP based protocols to exchange messages in a format understood by source device 101 and target device 102.

In some embodiments, source device 120 is adapted to instruct, and target device 102 is adapted to install. In some embodiments the source code may comprise network protocol server stacks for serving files, for example HTTP (Hypertext Transfer Protocol), FTP (File Transfer Protocol) or TFTP (Trivial File Transfer Protocol). In some embodiments the target code may comprise network protocol client stacks for downloading files, for example HTTP, FTP or TFTP. In some embodiments the target code may comprise an application adapted to install software to target digital memory hardware 121. In some embodiments the target code may comprise an operating system, such as Linux, Android or iOS, offering an API (Application Programming Interface) for installing software installation files. In some embodiments, the target code may comprise middleware supporting installation of software installation files.

In some embodiments, source device 101 may be connected to a server 103 via a network connection 131. In some embodiments, network connection 131 may be via a wireless network such as WiFi. In some embodiments, network connection 131 may be over a WAN.

In some embodiments, source device 101 may communicate with server 103 using network connection 131 to acquire an installation file for a software module and store the installation file in the source digital memory hardware 111. In such embodiments, source code may comprise network protocol client stacks for downloading files, such as HTTP, FTP or TFTP. In such embodiments, source device 101 may use network connection 132 to instruct target device 102 to acquire the installation file and to install the installation file to target digital memory hardware 121. Source device 101 may send the installation file to target device 102 using network connection 132. Alternately, source device 101 may instruct target device 102 to initiate a communication session for downloading the installation file from source digital memory hardware 111 using a network download protocol such as HTTP, FTP or TFTP over network connection 132.

In some embodiments, target device 102 may have a network connection 133 to the server. In such embodiments, source device 101 may instruct target device 102 to download the installation file from server 103 using a network protocol, for example HTTP, FTP or TFTP, over network connection 133.

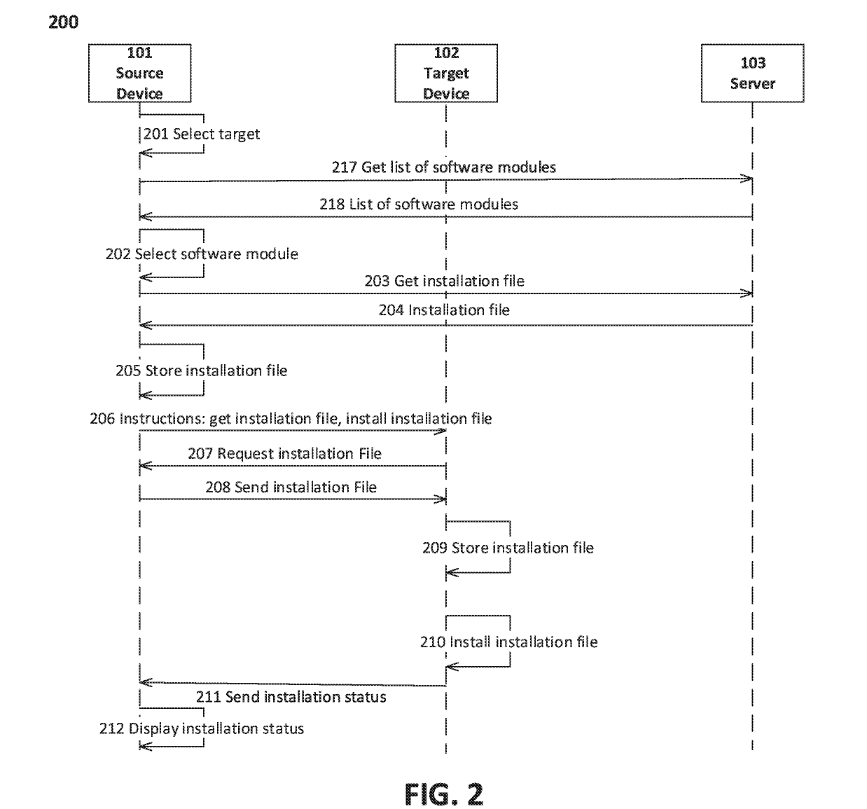

Reference is now made to FIG. 2, showing a sequence diagram of an optional flow of operations 200 according to some embodiments of the present invention. In such embodiments, on source device 101 a user may select a target device. The source device may have a list of predefined target devices, or may execute code to detect connected target devices prior to allowing a user to select a target device, for example by sending query messages or by listening to periodic beacon messages. Target devices may execute software enabling discovery by a source device, for example by responding to queries or by sending periodic beacon messages. In some embodiments the user may interact with the source device via a remote access network protocol such as Telnet.

In other embodiments, the source device may comprise a display and a keyboard or touch interface. In such embodiments the source device may present the list of predefined or detected target devices on the display, and the user's selection of target device may be delivered using the keyboard or touch interface.

In some embodiments, the source device may communicate with server 103 to request 217 a list of software modules for installing on the selected target device. The server sends 218 a list of software modules for installing on the selected target device. The user now selects 202 a software module to install. In some embodiments the user may select more than one module to install. In some embodiments the user may interact with the source device via a remote access network protocol such as Telnet. In other embodiments, the source device may comprise a display and a keyboard or touch interface. In such embodiments the source device may present the list of software modules on the display, and the user's selection of software may be delivered using the keyboard or touch interface.

The source device may request 203 an installation file for the selected software module from the server, for example by initiating an FTP session. The server may send 204 the installation file to the source device. The source device may store 205 the installation file in digital memory hardware local to the source device.

The source device may send instructions 206 to the selected target device 102 to acquire and install the installation file. The target device may request 207 the installation file from the source device, for example by initiating a TFTP session. The source device may send 208 the installation file to the target device. The target device may store 209 the installation file to a digital memory hardware local to the target device and may install 210 the installation file to the digital memory hardware local to the target device.

In some embodiments the target device may report the status of installation to the source device. In such embodiments, the target device may send installation status 211 to the source device. In 212 the source device may display the installation status to the user, for example a message on the source device's display. The user may also interact with the source device using a remote access network protocol such as Telnet to inspect the installation status.

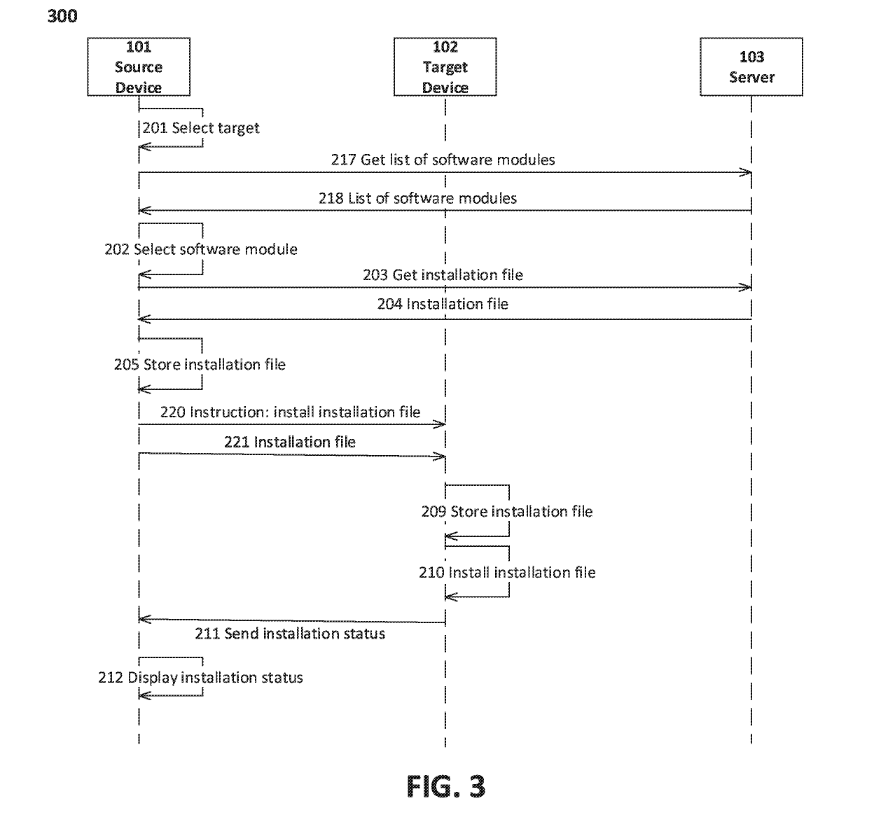

Referring now to FIG. 3, showing a sequence diagram of another optional flow of operations 300 according to some embodiments of the present invention. In such embodiments, the source device may send the installation file the target device without the target device making a request. The user may select 201 the target device on the source device, then the source device may request 217 a list of software modules from the server. The server may send 218 the list of modules to the source device and the user may select 202 a software module to install. The source device may request 203 from the server the installation file for the selected software module and the server may send 204 the installation file to the source device. The source device may store 205 the installation file to a digital memory hardware local to the source device. The source device may now instruct 220 the target device to install the installation file and may send 221 the installation file to the target device. The target device 209 may store the installation file to a digital memory hardware local to the target device and may install 210 the installation file to the digital memory hardware local to the target device.

The target device may send installation status 211 to the source device. In 212 the source device may display the installation status to the user.

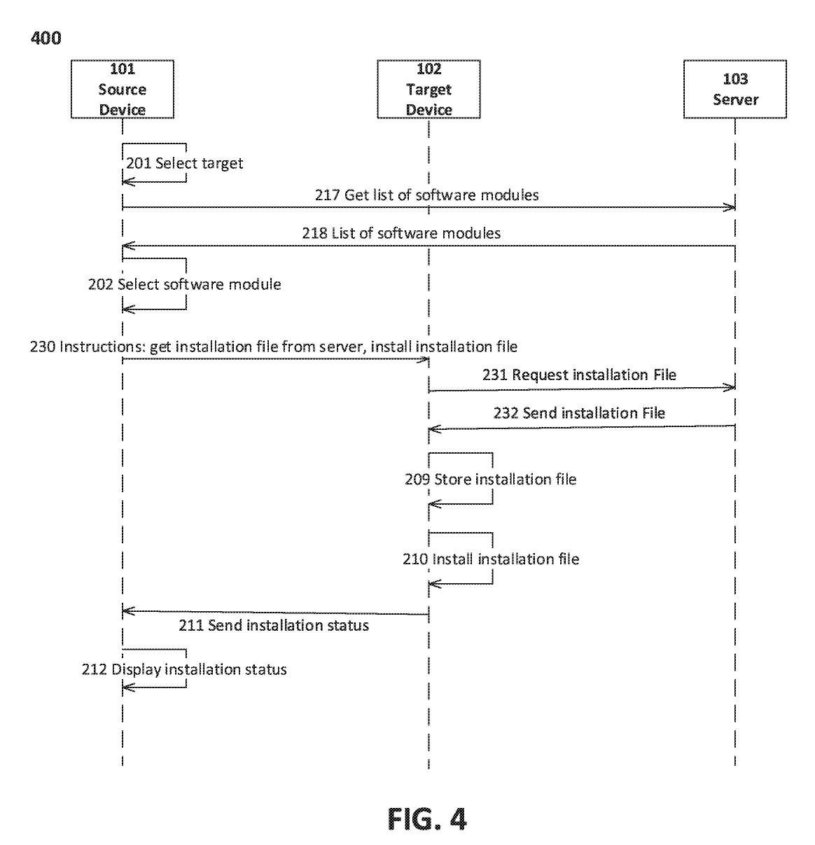

Referring now to FIG. 4, showing a sequence diagram of another optional flow of operations 400 according to some embodiments of the present invention. In such embodiments, the target device may acquire the installation file from a server. The user may select 201 the target device on the source device, after which the source device may request 217 a list of software modules from the server. The server may send 218 the list of modules to the source device and the user may select 202 a software module to install. The source device may instruct 230 the target device to acquire the installation file from the server and to install the installation file. The target device may request 231 the installation file from the server, for example by initiating an FTP session. The server may send 232 the installation file to the target device. The target device 209 may store the installation file to a digital memory hardware local to the target device and may install 210 the installation file to the digital memory hardware local to the target device.

The target device may send installation status 211 to the source device. In 212 the source device may display the installation status to the user.

In some installations the server storing the installation file may be different from the server storing the list of software modules to install.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant network connections and IP based communication protocols will be developed and the scope of the terms “network connection” and “IP base communication protocols” are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A network connected device, adapted to instruct, comprising:
a local digital memory hardware;
a code storage storing a code;
a hardware processor coupled to said local digital memory hardware and said code storage for executing said code for:
receiving instructions to install a software module in a target device;
acquiring an installation file of said software module from a server via a network;
storing said installation file to said local digital memory hardware;
instructing said target device to participate in establishing a network connection between said network connected device and said target device for installing said installation file on a local memory of said target device; and
instructing said target device to use said network connection for downloading said installation file from said local digital memory hardware for installation.

2. The network connected device of claim 1, wherein said receiving instructions to install a software module comprises:
acquiring a list of software modules from said server;
presenting said list of software modules to a user;
receiving said user's selection of one software module of said list of software modules; and
assigning said user's selection of one software module to be said software module.

3. The network connected device of claim 1, wherein said hardware processor further executes said code for:
discovering a set of target devices;
presenting to a user a list of target devices comprising said set of target devices;
receiving said user's selection of one target device of said list of target devices; and
assigning said user's selection of one target device to be said target device.

4. The network connected device of claim 1, wherein said hardware processor further executes said code for:
receiving installation status information from said target device on said network connection; and
presenting said installation status information to a user.

5. A method for instructing, comprising:
on a source device:
receiving instructions to install a software module in a target device;
acquiring an installation file of said software module from a server via a network;
storing said installation file to a local digital memory hardware;
instructing said target device to participate in establishing a network connection between said source device and said target device for installing said installation file on a local memory of said target device; and
instructing said target device to use said network connection for downloading said installation file from said local digital memory hardware for installation.

6. The method of claim 5, wherein said receiving instructions to install a software module comprises:
acquiring a list of software modules from said server;
presenting said list of software modules to a user;
receiving said user's selection of one software module of said list of software modules; and
assigning said user's selection of one software module to be said software module.

7. The method of claim 5, further comprising:
discovering a set of target devices;
presenting to a user a list of target devices comprising said set of target devices;
receiving said user's selection of one target device of said list of target devices; and
assigning said user's selection of one target device to be said target device.

8. The method of claim 5, further comprising:
receiving installation status information from said target device on said network connection; and
presenting said installation status information to a user.

9. A method, comprising:
receiving instructions on a source device to install a software module in a target device;
acquiring an installation file of said software module on a source device from a server via a network;
storing said installation file to a digital memory hardware local to said source device;
said source device instructing said target device to participate in establishing a network connection between said source device and said target device for installing said installation file on a digital memory hardware local to said target device;
said target device participating in establishing a network connection between said target device and said source device;
said source device instructing said target device to use said network connection for downloading said installation file from said digital memory hardware local to said source device for installation;
said target device using said network connection for downloading said installation file from said source device to said digital memory hardware local to said target device for installation; and
said target device installing said installation file to said local digital memory hardware.

10. The method of claim 9, wherein said receiving instructions on a source device to install a software module comprises:
acquiring a list of software modules from said server;
presenting said list of software modules to a user;
receiving said user's selection of one software module of said list of software modules; and
assigning said user's selection of one software module to be said software module.

11. The method of claim 9, further comprising:
discovering on said source device a set of target devices;
presenting to a user a list of target devices comprising said set of target devices;
receiving said user's selection of one target device of said list of target devices; and
assigning said user's selection of one target device to be said target device.

12. The method of claim 9, further comprising:
said target device using said network connection to send installation status information;
said source device receiving said installation status information; and
said source device presenting said installation status information to a user.
